(19) United States
(12) Patent Application Publication
(10) Pub. No.: US 2025/0226139 A1
(43) Pub. Date: Jul. 10, 2025

(54) SOLENOID COIL ASSEMBLY AND MANUFACTURING METHOD THEREOF

(71) Applicant: HL KLEMOVE CORP., Incheon (KR)

(72) Inventors: Sanghyun JIN, Pyeongtaek-si (KR); Jihoon HAN, Pyeongtaek-si (KR)

(21) Appl. No.: 18/607,768

(22) Filed: Mar. 18, 2024

(30) Foreign Application Priority Data
Jan. 8, 2024 (KR) 10-2024-0003156

(51) Int. Cl. H01F 7/20; H01F 27/29; H01F 27/32; H01F 41/10

(52) U.S. Cl. CPC H01F 7/20; H01F 27/292; H01F 27/325; H01F 41/10

(57) ABSTRACT

Disclosed are a solenoid coil assembly and a manufacturing method thereof. The solenoid coil assembly according to an embodiment may include a bobbin including a bobbin body being in a shape of a hollow cylinder, wherein a coil is wound on the bobbin body, and a socket provided on an upper surface of the bobbin body, wherein a lead wire of the coil is positioned at the socket, a bobbin case including a socket through hole through which the socket is exposed to outside, the bobbin case surrounding the bobbin, and a pin housing formed integrally with a lead pin connected to the socket, coupled to the bobbin case, and configured to electrically connect the lead wire of the coil to the lead pin.

### CROSS-REFERENCE TO RELATED APPLICATION(S)

This application is based on and claims priority under 35 U.S.C. § 119 to Korean Patent Application No. 10-2024-0003156, filed on Jan. 8, 2024, in the Korean Intellectual Property Office, the disclosure of which is incorporated by reference herein in its entirety.

### BACKGROUND

### 1. Field

The disclosure relates to a solenoid coil assembly and a manufacturing method thereof, and more particularly, to a solenoid coil assembly capable of improving productivity by preventing a lead pin or a socket from being deformed or damaged by a force applied in an axial direction of a bobbin to couple the lead pin to the socket at which a lead wire of a coil is positioned during a manufacturing process, and omitting a process and member for electrical connection of the lead pin and the lead wire of the coil, and a method of manufacturing the solenoid coil assembly.

### 2. Description of the Related Art

In general, various types of brake systems for obtaining the braking force are proposed for vehicles. The brake systems for vehicle include the Anti-lock Brake System (ABS) which prevents the vehicle from skidding, the Electronic Hydraulic Brake (EHB), and the Electronic Stability Control system (ESC).

Such a brake system for vehicle includes a plurality of solenoid valves for controlling braking hydraulic pressure toward the wheel brakes and an Electronic Control Unit (ECU) for controlling the solenoid valves. Each solenoid valve includes a solenoid coil assembly on which a coil is wound to form a magnetic field upon application of power, and a valve assembly which opens or closes an internal flow path by an electromagnetic field formed in the solenoid coil assembly.

Meanwhile, a typical solenoid coil assembly includes, as shown in FIGS. 1 and 2, a hollow cylindrical bobbin 10 on which a coil 11 is wound in the circumferential direction and a socket 12 is provided at the top, a bobbin case 20 including a lower case 21 and an upper case 22 to surround the bobbin 10, and a lead pin 30 coupled to the socket 12 in the axial direction of the bobbin 10.

In the typical solenoid coil assembly, because there is no component for supporting the lead pin 30 in the axial direction of the bobbin 10 when the lead pin 30 is pressed in the axial direction of the bobbin 10 to be coupled to the socket 12, except for the socket 12, the socket 12 or the lead pin 30 may be easily deformed or damaged.

Also, in the typical solenoid coil assembly, when the lead pin 30 is pressed in the axial direction of the bobbin 10 to be coupled to the socket 12, the socket 12 or the lead pin 30 may be damaged due to excessive insertion of the lead pin 30 or a poor connection may occur due to insufficient insertion of the lead pin 30. In order to prevent such damage or poor connection, a process for setting and adjusting an appropriate insertion height of the lead pin 30 from the socket 12 is required, which deteriorates productivity.

Furthermore, the typical solenoid coil assembly additionally requires a member or process for coupling the lead pin 30 to the lead wire of the coil 11 after the lead pin 30 is inserted into the socket 12, which further deteriorates productivity.

### SUMMARY

It is an aspect of the disclosure to provide a solenoid coil assembly capable of preventing a lead pin or a socket from being deformed or damaged by an excessive force applied in an axial direction of a bobbin upon coupling between the lead pin and the socket at which a lead wire of a coil is positioned, and a method of manufacturing the solenoid coil assembly.

It is another aspect of the disclosure to provide a solenoid coil assembly capable of preventing, upon coupling between a lead pin and a socket at which a lead wire of a coil is positioned, deformation or damage of the socket or the lead pin due to an excessive insertion amount of the lead pin with respect to the socket and a poor connection due to an insufficient insertion amount of the lead pin with respect to the socket, and a method of manufacturing the solenoid coil assembly.

It is another aspect of the disclosure to provide a solenoid coil assembly capable of omitting a process for adjusting an appropriate height of a lead pin from a socket for stable coupling between the lead pin and the socket at which a lead wire of a coil is positioned, and a method for manufacturing the solenoid coil assembly.

It is another aspect of the disclosure to provide a solenoid coil assembly capable of omitting a member and process for connecting a lead pin to a lead wire of a coil in the state in which the lead pin is coupled to the socket at which the lead wire of the coil is positioned, and a method of manufacturing the solenoid coil assembly.

Additional aspects of the disclosure will be set forth in part in the description which follows and, in part, will be obvious from the description, or may be learned by practice of the disclosure.

In accordance with an embodiment of the disclosure, there may be provided a solenoid coil assembly including a bobbin including a bobbin body being in a shape of a hollow cylinder, wherein a coil is wound on the bobbin body, and a socket provided on an upper surface of the bobbin body, wherein a lead wire of the coil is positioned at the socket, a bobbin case including a socket through hole through which the socket is exposed to outside, the bobbin case surrounding the bobbin, and a pin housing formed integrally with a lead pin connected to the socket, coupled to the bobbin case, and configured to electrically connect the lead wire of the coil to the lead pin.

The bobbin may further include a lower flange provided in a lower portion of the bobbin body and configured to limit a lower winding range of the coil, and an upper flange provided in an upper portion of the bobbin body and configured to limit an upper winding range of the coil, wherein the socket is provided at a side of an upper surface of the upper flange and an indicator is formed at another side of the upper surface of the upper flange.

The upper flange may further include a lead wire through hole provided adjacent to the socket such that the lead wire of the coil is positioned at the socket.

The bobbin case may further include a lower case provided on a lower surface of the bobbin, and an upper case coupled to the lower case and surrounding an upper surface and a side surface of the bobbin, wherein the socket through hole is provided at a side of an upper portion of the upper case and an indicator through hole through which the indicator is exposed to the outside is provided at another side of the upper portion of the upper case.

The upper case may further include an inner circumferential extension portion bent toward an inner circumferential surface of the bobbin and surrounding an upper portion of the inner circumferential surface of the bobbin.

The pin housing may surround an upper surface and a side surface of the upper case and include a coupling hook coupled with a first coupling portion provided at a lower end of the upper case.

The pin housing may further include a coupling hook slit provided at both sides of the coupling hook and extending in an axial direction of the pin housing.

The first coupling portion may be provided in a shape of a groove depressed in the axial direction of the bobbin case at the lower end of the upper case.

The pin housing may surround the upper surface of the upper case and an upper portion of the side surface of the upper case and include a coupling groove coupled with a second coupling portion provided at an upper end of the side surface of the upper case.

The second coupling portion may be provided in a shape of a circular ring extending in a circumferential direction at the upper end of the side surface of the upper case.

The second coupling portion may be provided in a shape of a protrusion protruding in a diameter direction from the upper end of the side surface of the upper case.

The upper case may further include at least one support protrusion supporting an inner surface of an upper portion of the pin housing.

The pin housing may include an indicator coupling hole accommodating an upper end of the indicator.

The pin housing may further include a press-fit rib protruding from an inner circumferential surface of the indicator coupling hole toward a center of the indicator coupling hole, extending in an axial direction of the pin housing, and configured to fix the upper end of the indicator.

The lead pin may include a plug portion provided at a side of the upper portion of the pin housing and electrically connected to the lead wire of the coil positioned at the socket, a connector portion protruding upward from a center of the upper portion of the pin housing, and a connection portion positioned inside the upper portion of the pin housing and connecting the plug portion to the connector portion, wherein the lead pin is integrated into the pin housing by insert injection.

An upper end of the plug portion may protrude upward from the pin housing, and the plug portion may include a coil coupling hole provided at a lower end of the plug portion and electrically connected to the lead wire of the coil.

The connector portion may include a connector pin protruding upward from the pin housing at an upper end of the connector portion, wherein a lower end of the connector pin protrudes from a lower surface of the upper portion of the pin housing, and a limiting protrusion protruding from both sides of the connector pin at the lower end of the connector pin.

The socket may include a first socket at which a first lead wire of the coil is positioned, and a second socket at which a second lead wire of the coil is positioned.

The lead pin may include a first lead pin, wherein at least one portion of the first lead pin is inserted in the first socket and electrically connected to the first lead wire, and a second lead pin, wherein at least one portion of the second lead pin is inserted into the second socket and electrically connected to the second lead wire.

In accordance with an embodiment of the disclosure, there may be provided a method of manufacturing a solenoid coil assembly including a bobbin including a socket and an indicator provided on an upper surface of the bobbin, the bobbin being in a shape of a hollow cylinder, a bobbin case including a socket through hole and an indicator through hole formed in an upper portion of the bobbin case, the bobbin case surrounding the bobbin, and a pin housing formed integrally with a lead pin, including an indicator coupling hole, and surrounding at least one portion of the bobbin case, the method including: a coil winding operation of winding a coil on the bobbin such that a lead wire is positioned at the socket, a bobbin case coupling operation of coupling the bobbin case with the bobbin such that the socket and the indicator are respectively exposed through the socket through hole and the indicator through hole, and a pin housing coupling operation of coupling the pin housing with the bobbin case such that a lower end of the lead pin is inserted in the socket and an upper end of the indicator is accommodated in the indicator coupling hole to electrically connect the lead wire of the coil to the lead pin.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view showing a disassembled state of a typical solenoid coil assembly;

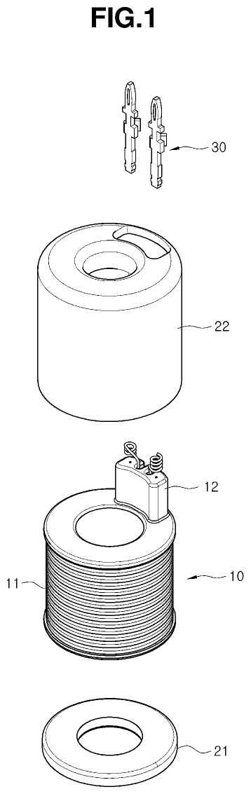

FIG. 2 is a front view showing an assembled state of a typical solenoid coil assembly;

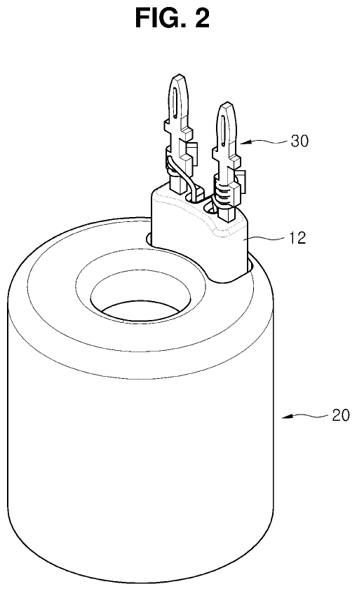

FIG. 3 is a perspective view showing a disassembled state of a solenoid coil assembly according to an embodiment of the disclosure;

FIG. 4 is a perspective view showing an assembled state of a solenoid coil assembly according to an embodiment of the disclosure;

FIG. 5 is a top view showing an assembled state of a solenoid coil assembly according to an embodiment of the disclosure;

FIG. 6 is a cross-sectional view taken along line A-A′ of FIG. 5;

FIG. 7 is a cross-sectional view taken along line B-B′ of FIG. 5;

FIG. 8 is a cross-sectional view taken along line C-C′ of FIG. 5;

FIG. 9 is a cross-sectional view showing an embodiment of a cross section taken along line A-A′ of FIG. 5; and

FIG. 10 is a cross-sectional view showing an embodiment of a cross section taken along line B-B′ of FIG. 5.

### DETAILED DESCRIPTION

Hereinafter, embodiments of the disclosure will be described in detail with reference to the accompanying drawings. The following embodiments are provided to sufficiently transfer the concepts of the disclosure to one of ordinary skill in the technical art to which the disclosure belongs. However, the disclosure is not limited to these embodiments, and may be embodied in another form. In the drawings, parts that are irrelevant to the descriptions may be not shown in order to clarify the disclosure, and also, for easy understanding, the sizes of components are more or less exaggeratedly shown.

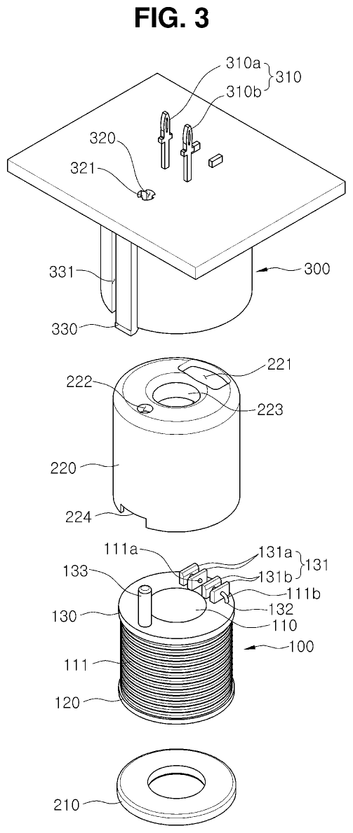

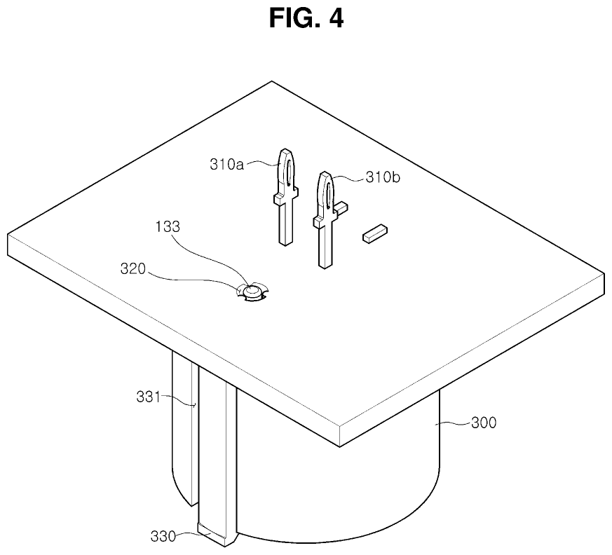

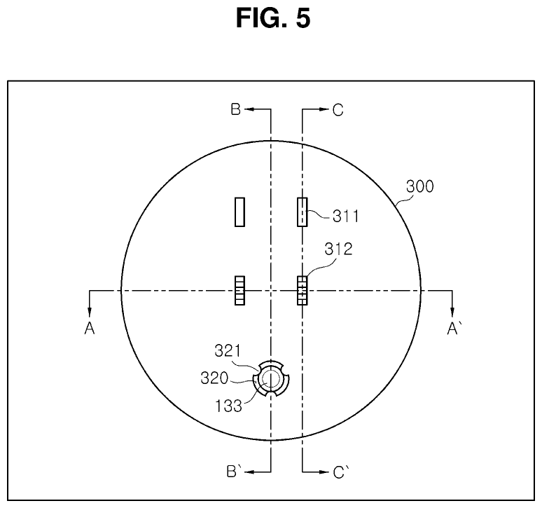

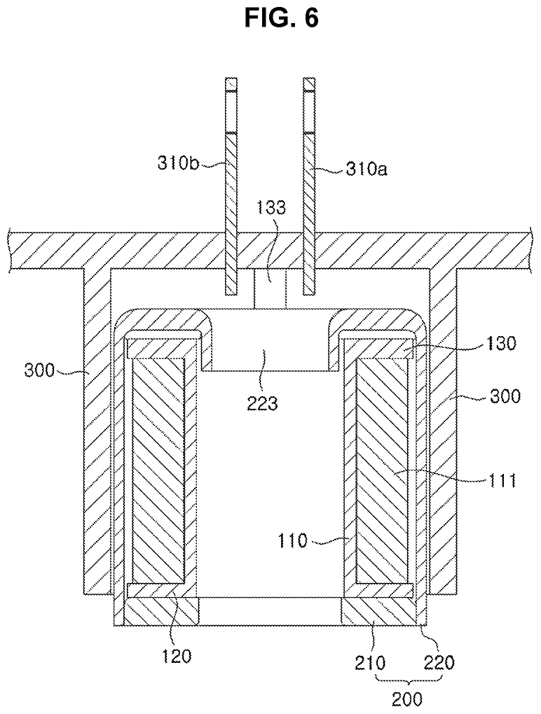

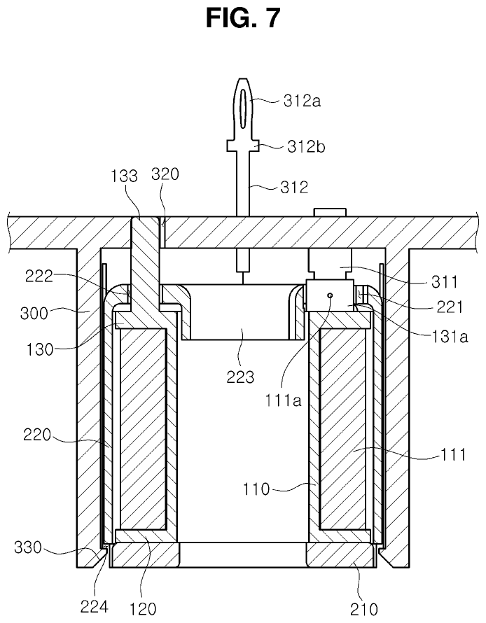

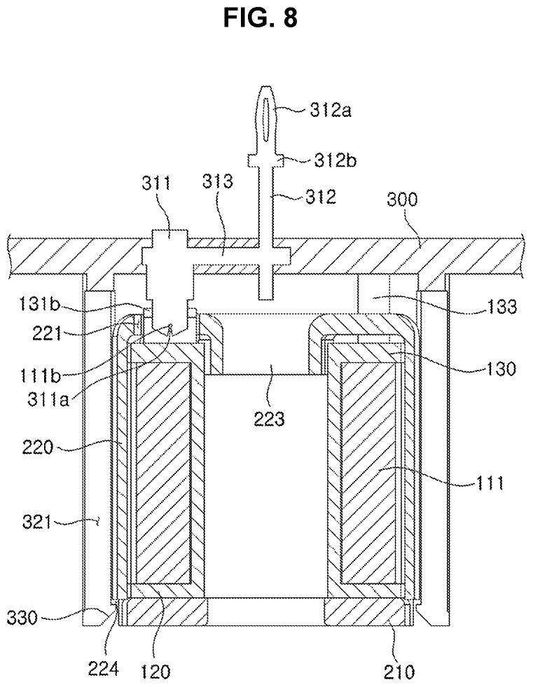

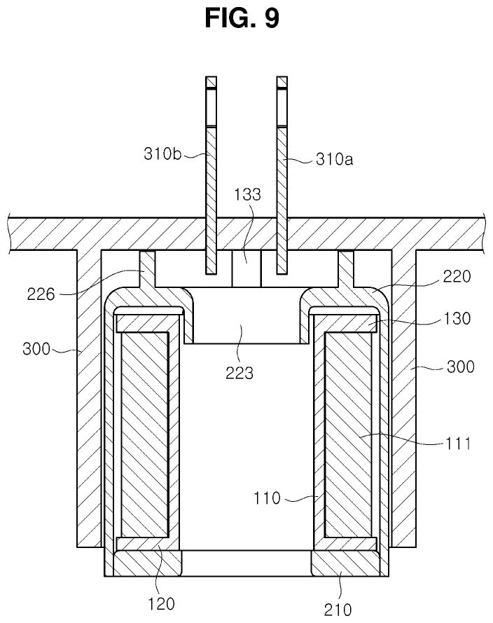

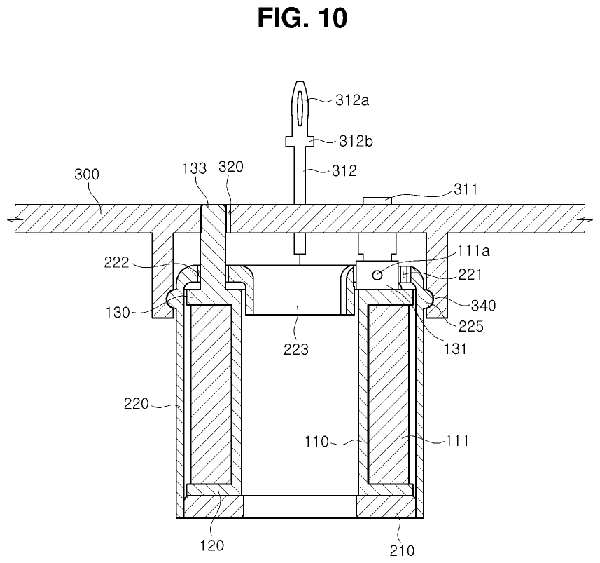

FIGS. 3 and 4 are perspective views respectively showing a disassembled state and an assembled state of a solenoid coil assembly according to an embodiment of the disclosure. Also, FIG. 5 is a top view showing an assembled state of a solenoid coil assembly according to an embodiment of the disclosure. Also, FIG. 6 is a cross-sectional view taken along line A-A′ of FIG. 5, FIG. 7 is a cross-sectional view taken along line B-B′ of FIG. 5, and FIG. 8 is a cross-sectional view taken along line C-C′ of FIG. 5. Also, FIG. 9 is a cross-sectional view showing an embodiment of a cross section taken along line A-A′ of FIG. 5, and FIG. 10 is a cross-sectional view showing an embodiment of a cross section taken along line B-B′ of FIG. 5.

Referring to FIGS. 3 to 10, a solenoid coil assembly according to an embodiment of the disclosure may include a bobbin 100 on which a coil 111 is wound, a bobbin case 200 surrounding the bobbin 100, and a pin housing 300 into which a lead pin 310 is integrated and which is coupled to the bobbin case 200 to cover at least one part of an upper portion of the bobbin case 200.

The bobbin 100 may include a bobbin body 110 being in a shape of a hollow cylinder, a lower flange 120 provided in a lower portion of the bobbin body 110 and being in a shape of a circular ring plate, and an upper flange 130 provided in an upper portion of the bobbin body 110 and being in a shape of a circular ring plate.

The bobbin body 110 may be provided in the shape of a hollow cylinder, as described above, wherein a sleeve (not shown), etc. of a valve assembly is positioned on an inner circumferential surface of the bobbin body 110 and the coil 111 is wound on an outer circumferential surface of the bobbin body 110 in a circumferential direction of the bobbin body 110. Both ends of the coil 111 wound on the bobbin body 110 may be positioned on the upper portion of the bobbin body 110. Also, the bobbin body 110 may be made of a synthetic resin as an insulating material so as not to affect a magnetic field generated when current is supplied to the wound coil 111.

The lower flange 120 may be integrated into the bobbin body 110 in the lower portion of the bobbin body 110, as shown in FIGS. 3 and 6, or the lower flange 120 may be provided as a separate component and coupled to the lower portion of the bobbin body 110 through a structure, such as a hook or groove, although not shown.

The lower flange 120 may limit a lower winding range of the coil 111 wound on the bobbin body 110, and the lower flange 120 may be made of a synthetic resin as an insulating material, like the bobbin body 110. A circular hole formed in an inner portion of the lower flange 120 may have the same cross sectional area as a circular hole formed in an inner portion of the bobbin body 110.

The upper flange 130 may be integrated into the bobbin body 110 in the upper portion of the bobbin body 110, as shown in FIGS. 3 and 6, or the upper flange 130 may be provided as a separate component and coupled to the upper portion of the bobbin body 110 through a structure, such as a hook or groove, although not shown.

The upper flange 130 may limit an upper winding range of the coil 111 wound on the bobbin body 110, and the upper flange 130 may be made of a synthetic resin as an insulating material, like the bobbin body 110. A circular hole formed in an inner portion of the upper flange 130 may have the same cross sectional area as the circular hole formed in the inner portion of the bobbin body 110.

Accordingly, the bobbin 100 may be manufactured as an injection molded product into which the bobbin body 110, the lower flange 120, and the upper flange 130 are integrated. Alternatively, by coupling the bobbin body 110, the lower flange 120, and the upper flange 130 provided as separate components to each other, the bobbin 100 may be provided in a shape of a hollow cylinder provided with ring-shaped flanges at the lower and upper ends.

Meanwhile, the upper flange 130 may include a socket 131 provided at a side of an upper surface of the upper flange 130, a lead wire through hole 132 adjacent to the socket 131, and an indicator 133 provided at another side of the upper surface.

The socket 131 may be an Insulation Displacement Connection (IDC) type socket provided in the shape of two ribs spaced a preset distance from each other to be parallel to each other. Herein, the IDC may mean an electrical connection structure capable of simplifying a product manufacturing process because a process or a member, such as a bolt or a nut, for fixing the lead wire of the coil 11 to the lead pin 310 is omitted.

To this end, an upper end of the socket 131 may be in a shape of a chamfer such that a plug portion 311 which will be described below is easily inserted between the two ribs. Also, the socket 131 may be molded integrally with the upper flange 130 and include a conductive film formed by deposition or the like at a portion being in contact with the plug portion 311.

Also, the socket 131 may be provided as a first socket 131a and a second socket 131b that is adjacent to the first socket 131a, as shown in FIG. 3. More specifically, the first socket 131a may be symmetrical to the second socket 131b with respect to an imaginary straight line passing an axial center of the bobbin 100 in a diameter direction of the bobbin 100, as shown in FIG. 5.

The lead wire through hole 132 may penetrate the upper flange 130 from the outer circumferential surface of the bobbin body 110 such that an end of the coil 111 wound on the bobbin body 110 is positioned at the socket 131 configured as described above. Also, because the socket 131 is provided as the first socket 131a and the second socket 131b, as described above, two lead wire through holes 132 may be provided in such a way as to be respectively adjacent to the first socket 131a and the second socket 131b. In this case, the two lead wire through holes 132 may also be symmetrical to each other with respect to an imaginary straight line passing the axial center of the bobbin 100 in the diameter direction of the bobbin 100.

Accordingly, a first lead wire 111a and a second lead wire 111b that are both ends of the coil 111 wound on the bobbin body 110 may extend in the axial direction of the bobbin body 110 and be respectively positioned at the first socket 131a and the second socket 131b via the lead wire through holes 132, as shown in FIGS. 3, 7, and 8. Also, an end of the first lead wire 111a and an end of the second lead wire 111b may be respectively provided between the first socket 131a and the second socket 131b.

Also, the first lead wire 111a and the second lead wire 111b may be firmly fixed to the first socket 131a and the second socket 131b, respectively, to be prevented from departing from the first socket 131a and the second socket 131b by a force applied in the axial direction of the bobbin 100 while respectively connecting to the lead pin 310.

The indicator 133 may be used to visually check assembly completion of the solenoid coil assembly according to the disclosure. The indicator 133 may be in a shape of a faceted cylinder including a circular cylinder and protrude upward from the upper surface of the upper flange 130. In this case, the indicator 133 may be positioned at an opposite side of the side at which the socket 131 is positioned on the upper flange 130, as shown in FIG. 5.

Also, an axial center of the indicator 133 may be positioned on an imaginary straight line passing the axial center of the bobbin 100 in the diameter direction of the bobbin 100. Also, a protrusion height of the indicator 133 from the upper surface of the upper flange 130 may be equal or similar to a height of an upper surface of the pin housing 300 after the solenoid coil assembly according to the disclosure is completely assembled. Also, the indicator 133 may be manufactured as an injection molded product integrally with the upper flange 130, like the socket 131.

Meanwhile, the bobbin case 200 may include a lower case 210 being in a shape of a circular ring plate, and an upper case 220 coupled to the lower case 210 and surrounding the bobbin 100.

A circular hole formed in an inner portion of the lower case 210 may have a cross-sectional area that is equal or similar to that of a cylindrical hole formed in the inner portion of the bobbin body 110, as shown in FIG. 6. Also, although not shown, the lower case 210 may further include a structure, such as a groove or a hook, for coupling with the upper case 220.

Also, an external diameter of the lower case 210 may be equal or similar to an internal diameter of the upper case 200 such that the lower case 210 is inserted inside the upper case 220 and coupled to the upper case 220. Also, the lower case 210 may be made of a synthetic resin as an insulating material so as not to affect a magnetic field generated when current is supplied to the wound coil 111, like the bobbin 100.

The upper case 220 may include a socket through hole 221 and an indicator through hole 222. The socket through hole 221 may penetrate the upper portion of the upper case 220 to expose the socket 131 to outside in the state in which the bobbin case 200 is coupled to the bobbin 110 in such a way as to surround the bobbin 100. The socket through hole 221 may be positioned such that the lead wire through hole 132 is not exposed to the outside of the bobbin case 200, thereby maximally preventing a foreign material from entering the coil 111 wound on the bobbin body 110.

Also, the indicator through hole 222 may penetrate the upper portion of the upper case 220 to expose the indicator 133 to the outside in the state in which the bobbin case 200 is coupled to the bobbin 100 in such a way as to surround the bobbin 100. Accordingly, the socket 131 and the indicator 133 may be exposed upward from the bobbin case 200 completely assembled with the bobbin 100 therein.

Also, the upper case 220 may include an inner circumferential extension portion 223 bent toward the cylindrical hole provided in the inner portion of the bobbin 100 from the upper surface and surrounding an upper portion of the inner circumferential surface of the bobbin 100, as shown in FIGS. 3 and 6. The inner circumferential extension portion 223 may firmly fix the bobbin case 200 to the bobbin 100 and be in close contact with the inner circumferential surface of the bobbin 100. Also, the inner circumferential extension portion 223 may further include a structure for fixing the sleeve, etc. of the valve assembly positioned on the inner circumferential surface of the bobbin body 110 as described above, which is not shown.

Also, the upper case 220 may further include a first coupling portion 224 at the lower end to fix the pin housing 300 to the bobbin case 200, wherein the first coupling portion 224 may be in a shape of a groove depressed in the axial direction of the bobbin case 200, as shown in FIGS. 3, 7, and 8. In this case, at least two first coupling portions 224 may be provided to firmly fix the pin housing 300 to the bobbin case 200.

Also, the upper case 220 may include a second coupling portion 225 at the upper portion, wherein the second coupling portion 225 may be in a shape of a protrusion, as shown in FIG. 10. In this case, the pin housing 300 may surround only an upper portion of a side surface of the bobbin case 200 without surrounding the entire side surface of the bobbin case 200 being in the shape of the cylinder. Also, the pin housing 300 may include a structure being in a shape of a groove at a location corresponding to the second coupling portion 225 to firmly couple the pin housing 300 to the upper case 220.

Also, at least two second coupling portions 225 may be provided to firmly fix the pin housing 300 to the bobbin case 200, like the first coupling portions 224. Alternatively, the second coupling portion 225 may extend along the outer circumferential surface of the upper case 220 in the circumferential direction to form a circular ring shape.

Also, the upper case 220 may further include at least two support protrusions 226 protruding upward from the upper surface, as shown in FIG. 9. Herein, the support protrusion 226 may support an inner surface of the upper portion of the pin housing 300 while the pin housing 300 is coupled to the upper case 220 to cover the upper case 220 from above, thereby maintaining a gap between an upper surface of the bobbin case 200 and the inner surface of the upper portion of the pin housing 300. Accordingly, the solenoid coil assembly according to the disclosure may further prevent the lead pin 310 from being excessively inserted into the socket 131 while the pin housing 300 is coupled to the bobbin case 300 in the axial direction of the bobbin case 200.

Also, the upper case 220 may be made of a synthetic resin as an insulating material so as not to affect a magnetic field generated when current is supplied to the wound coil 111, like the lower case 210. Also, the upper case 220 of the bobbin case 200 may be coupled to the lower case 210 of the bobbin case 200 through various known coupling structures while the bobbin 100 is accommodated in an internal space of the bobbin case 200, although not shown. In this case, the first socket 131a and the first lead wire 111a positioned at the first socket 131a, the second socket 131b and the second lead wire 111b positioned at the second socket 131b, and the indicator 133 may be exposed to the outside from the bobbin case 200 completely assembled with the bobbin 100 therein.

Meanwhile, the pin housing 300 may be closed at the entire upper portion, have a side portion being in a shape of a hollow cylinder, include the lead pin 310 inserted into the upper portion, and be coupled to the bobbin case 200 in such a way as to surround the bobbin case 200 from above. The upper portion of the pin housing 300 is shown as a quadrangle. However, the upper portion of the pin housing 300 is not limited to a quadrangle and may be provided in various shapes including a circular shape.

The upper portion of the pin housing 300 may cover, as shown in FIGS. 3 to 9, the entire upper surface of the bobbin case 200, and the side portion of the pin housing 300, which is in the shape of the hollow cylinder, may surround the entire side surface of the bobbin case 200.

The pin housing 300 may include a coupling hook 330 at a lower end of the side portion. The coupling hook 330 may be coupled to the first coupling portion 224 provided at the lower end of the upper case 220 to couple the pin housing 300 to the bobbin case 200. Also, the coupling hook 330 may include a coupling hook slit 331 at the both sides, and the coupling hook slit 331 may extend in an axial direction of the pin housing 300 such that the coupling hook 330 is deformable in a diameter direction of the pin housing 300 while moving downward along the side surface of the upper case 220 in the axial direction of the bobbin case 220.

Accordingly, while the pin housing 300 is coupled to the bobbin case 200, the coupling hook 330 may move along the side surface of the bobbin case 200 in the state of opening in the diameter direction of the pin housing 300, and when the coupling hook 330 arrives at the first coupling portion 224, the coupling hook 330 may be restored and fixed to the first coupling portion 224. Also, at least two coupling hooks 330 may be provided to firmly fix the pin housing 300 to the bobbin case 200, like the first coupling portions 224.

Also, the first coupling portion 224 may be in a shape of a hook protruding from the side surface of the bobbin case 200, and the pin housing 300 may include a structure of a coupling hole or a coupling groove, instead of the coupling hook 330, to couple the pin housing 300 to the bobbin case 200, which is not shown.

Meanwhile, because the coupling hook 330 configured as described above moves in the axial direction of the bobbin case 200 while being in close contact with the side surface of the bobbin case 200 during a process of coupling the pin housing 300 to the bobbin case 200, the side surface of the bobbin case 200 may be damaged.

To prevent damage to the side surface of the bobbin case 200, the upper portion of the pin housing 300 may cover the entire upper surface of the bobbin case 200, and the side portion of the pin housing 300, which is in the shape of the hollow cylinder, may surround an upper portion of the side surface of the bobbin case 200, as shown in FIG. 10.

In this case, the pin housing 300 may include a coupling groove 340 which is provided in the inner circumferential surface of the pin housing 300 and into which the second coupling portion 225 provided in a shape of a protrusion or a circular ring at an upper end portion of the upper case 220 is inserted.

Accordingly, the solenoid coil assembly according to the disclosure may fundamentally prevent damage that may occur on the side surface of the bobbin case 200 while the pin housing 300 is coupled to the bobbin case 200. Also, because the side portion of the pin housing 300, which is in the shape of the hollow cylinder, surrounds the upper portion of the side surface of the bobbin case 200, heat generated when current is supplied to the coil 111 may be relatively easily discharged to the outside, which further improves a heat dissipation effect.

Meanwhile, the pin housing 300 may be made of a synthetic resin as an insulating material so as not to affect a magnetic field generated by the coil 111 wound on the bobbin body 110, like the bobbin 100 and the bobbin case 200, and the lead pin 310 made of a metal material as a conductor may be integrated into the pin housing 300 through an insert injection process.

As shown in FIGS. 7 and 8, the lead pin 310 may include a plug portion 311 provided at an upper portion of the socket 131, a connector portion 312 provided at a center part of the upper portion of the pin housing 300, and a connection portion 313 connecting the plug portion 311 to the connector portion 312.

While the pin housing 300 is coupled to the bobbin case 200 in the axial direction of the pin housing 300, a lower end of the plug portion 311 may be inserted into the socket 131 to be electrically connected to the first lead wire 111a or the second lead wire 111b. To this end, the plug portion 311 may be positioned at a side of the upper portion of the pin housing 300 in the axial direction of the pin housing 300 such that the socket 131 is positioned at a lower portion of the plug portion 311.

Also, as shown in FIG. 8, the plug portion 311 may include a coil coupling hole 311a which is in a shape of a hole and to which the first lead wire 111a or the second lead wire 111b entered the plug portion 311 through a slit opening downward is fixed.

Therefore, in the solenoid coil assembly according to the disclosure, while the pin housing 300 is assembled with the bobbin case 200, the first and second lead wires 111a and 111b of the coil 111 may be electrically connected to the lead pin 310. Accordingly, a process or member for connecting lead wires of a coil to a lead pin in a process of manufacturing a typical solenoid coil assembly may be omitted, which greatly improves productivity.

Also, an upper end of the plug portion 311 may protrude from the upper surface of the pin housing 300 to easily manufacture a mold upon insert injection of the lead pin 310 and the pin housing 300 and firmly fix the lead pin 310 to the pin housing 300.

Also, because the upper end of the plug portion 311 protrudes from the upper surface of the pin housing 300, as described above, it may be possible to visually check whether the plug portion 311 is properly placed in the pin housing 300 in a process of manufacturing the solenoid coil assembly according to the disclosure.

The connector portion 312 may include a connector pin 312a protruding upward from the pin housing 300 to be electrically connected to a Printed Circuit Board (PCB), etc. provided in an apparatus (hereinafter, referred to a vehicle control apparatus) for a vehicle, such as Anti-lock Brake System (ABS), Electro Hydraulic Brake (EHB), and Electronic Stability Control System (ESC), in which the solenoid coil assembly according to the disclosure is installed.

Also, the connector portion 312 may be provided at the center part of the upper portion of the pin housing 300 in the axial direction of the pin housing 300. Also, the connector portion 312 may further include, as shown in FIG. 7, a limiting protrusion 312b protruding from both sides of the connection pin 312a at a lower end of the connector pin 312a to prevent the connector pin 312a from being excessively inserted into the PCB, etc.

Accordingly, a force applied to the connector pin 312a in the axial direction of the pin housing 300 to electrically connect the solenoid coil assembly according to the disclosure to the PCB of the vehicle control apparatus may be transferred to the plug portion 311 via the pin housing 300 without being directly transferred to the plug portion 311, which further prevents deformation or damage of the lead pin 310 and the socket 131.

Also, a lower end of the connector portion 312a may protrude from a lower surface of the upper portion of the pin housing 300 to firmly fix the lead pin 310 to the pin housing 300, as shown in FIG. 9. The lower end of the connector pin 312a may be spaced from the upper surface of the bobbin case 200 to be prevented from interfering with the sleeve (not shown), etc. of the valve assembly positioned on the inner circumferential surface of the bobbin body 110.

Also, the solenoid coil assembly according to the disclosure may include a member or structure for directly supporting the lower end of the connector portion 312 on the inner circumferential surface of the bobbin body 110 to further prevent the lead pin 310 from being deformed or damaged by a force applied in the axial direction of the pin housing 300 while the lead pin 310 is electrically connected to the first and second lead wires 111a and 111b of the coil 111, the PCB, etc.

As shown in FIG. 8, the connection portion 313 may connect the plug portion 311 provided at the socket 131 to the connector portion 312 provided at the center part of the pin housing 300 inside the pin housing 300, as described above. Also, as shown in FIG. 9, an end of the connection portion 313 may protrude to a side of the plug portion 311 with respect to the diameter direction of the pin housing 300, and another end of the connection portion 313 may protrude to a side of the connector portion 312 with respect to the diameter direction of the pin housing 300 to firmly fix the lead pin 310 to the pin housing 300.

Also, the lead pin 310 configured as described above may include the first lead pin 310a and the second lead pin 310b that are adjacent to each other to be respectively coupled to the first socket 131a and the second socket 131b, as shown in FIG. 3. More specifically, the first lead pin 310a may be symmetrical to the second lead pin 310b with respect to an imaginary straight line passing an axial center of the pin housing 300 in the diameter direction of the pin housing 300, like the first socket 131a and the second socket 131b.

Also, each of the first lead pin 310a and the second lead pin 310b may include all of the plug portion 311, the connector portion 312, and the connection portion 313 to form the same shape as described above.

Meanwhile, the pin housing 300 may include the indicator coupling hole 320 that is provided in the upper portion of the pin housing 30 and coupled to the indicator 133, and the coupling hook 330 or the coupling groove 340 that is coupled to the bobbin case 200.

The indicator coupling hole 320 may penetrate the upper portion of the pin housing 300 such that the upper end of the indicator 133 provided on the upper flange 130 and exposed upward from the bobbin case 200 via the indicator through hole 222 is coupled to the indicator coupling hole 320, as shown in FIGS. 3 and 7. Also, the indicator coupling hole 320 may include at least two press-fit ribs 321 protruding from the indicator coupling hole 320 along the axial direction of the pin housing 300, as shown in FIG. 5. Accordingly, upon insertion of the upper end of the indicator 133 into the indicator coupling hole 320, the press-fit ribs 321 may be press-fitted into an outer circumferential surface of the indicator 133 to thereby firmly fix the indicator 133 within the indicator coupling hole 320.

Accordingly, the solenoid coil assembly according to the disclosure may prevent deformation and damage of the socket 131 or the lead pin 310, which is caused by excessive insertion of the plug portion 311 of the lead pin 310 into the socket 131 provided on the bobbin 100, and prevent a poor connection caused by insufficient insertion of the plug portion 311 of the lead pin 310 into the socket 131 provided on the bobbin 100, thereby improving reliability of a product and further reducing an error rate.

Meanwhile, a method of manufacturing the solenoid coil assembly according to the disclosure may include a coil winding operation, a bobbin case coupling operation, and a pin housing coupling operation.

The coil winding operation may be a process of winding the coil 111 in the circumferential direction of the bobbin body 110. A winding range of the coil 111 may be limited in a lower direction by the lower flange 120 and in an upper direction by the upper flange 130.

More specifically, the bobbin body 110 may be in the shape of the hollow cylinder, wherein the valve assembly, etc. may be positioned on the inner circumferential surface of the bobbin body 110 and the coil 111 may be wound on the outer circumferential surface of the bobbin body 110 in the circumferential direction of the bobbin body 110.

The lower flange 120 may limit a lower winding range of the coil 111 wound on the bobbin body 110. The lower flange 120 may be integrated into the bobbin body 110 in the lower portion of the bobbin body 110. Alternatively, the lower flange 120 may be provided as a separate component and coupled to the lower portion of the bobbin body 110 through a structure, such as a hook or a groove, which is not shown. Also, the circular hole formed in the inner portion of the lower flange 120 may have the same cross-sectional area as the circular hole formed in the inner portion of the bobbin body 110.

The upper flange 130 may limit an upper winding range of the coil 111 wound on the bobbin body 110. The upper flange 130 may be integrated into the bobbin body 110 in the upper portion of the bobbin body 110. Alternatively, the upper flange 130 may be provided as a separate component and coupled to the upper portion of the bobbin body 110 through a structure, such as a hook or a groove, which is not shown. Also, the circular hole formed in the inner portion of the upper flange 130 may have the same cross-sectional area as the circular hole formed in the inner portion of the bobbin body 110.

Accordingly, by manufacturing the bobbin body 110, the lower flange 120, and the upper flange 130 as an integrated injection molding product or preparing the bobbin body 110, the lower flange 120, and the upper flange 130 as separate components and then coupling the bobbin body 110, the lower flange 120, and the upper flange 130 to each other, the bobbin 100 may be provided in the shape of a hollow cylinder with flanges each being in a shape of a circular ring at the lower and upper ends.

Also, in the coil winding operation, the first lead wire 111a of the coil 111 may be positioned at the first socket 131a provided in the shape of two ribs being parallel to each other, via the lead wire through hole 132 that is adjacent to the first socket 131a and provided in the upper flange 130. Also, the second lead wire 111b of the coil 111 may be positioned at the second socket 131b provided in the shape of two ribs being parallel to each other, via the lead wire through hole 132 that is adjacent to the second socket 131b and provided in the upper flange 130.

More specifically, the first socket 131a may be symmetrical to the second socket 131b with respect to an imaginary straight line passing the axial center of the bobbin 100 in the diameter direction of the bobbin 100, as shown in FIG. 5.

Also, because the socket 131 is provided as the first socket 131a and the second socket 131b, as described above, two lead wire through holes 132 may be provided to be respectively adjacent to the first socket 131a and the second socket 131b. In this case, the two lead wire through holes 132 may also be symmetrical to each other with respect to an imaginary straight line passing the axial center of the bobbin 100 in the diameter direction of the bobbin 100.

Accordingly, the first lead wire 111a and the second lead wire 111b which are both ends of the coil 111 wound on the bobbin body 110 may extend in the axial direction of the bobbin body 110, pass through the lead wire through holes 132, and then be respectively positioned at the first socket 131a and the second socket 131b, as shown in FIGS. 3, 7, and 8. Also, an end of the first lead wire 111a and an end of the second lead wire 111b may be respectively provided between the first socket 131a and the second socket 131b.

Meanwhile, the bobbin case coupling operation may be an operation of coupling the lower case 210 with the upper case 220 after the bobbin 100 on which winding of the coil 111 is completed is accommodated in the internal space of the bobbin case 200.

More specifically, in the bobbin case coupling operation, by aligning the lower case 210 below the bobbin 100, aligning the upper case 220 above the bobbin 100, and then moving the lower case 210 or the upper case 220 in the axial direction of the bobbin 100 to couple the lower case 210 with the upper case 220, the bobbin 100 may be accommodated in the internal space of the bobbin case 200. The upper case 220 and the bobbin 100 may be aligned based on the indicator 133 provided on the upper surface of the bobbin 100 and the indicator through hole 222 provided in the upper portion of the upper case 220.

Also, the inner diameter of the upper case 220 may be equal or similar to the outer diameter of the lower flange 120 and the outer diameter of the upper flange 130, and accordingly, after the bobbin 100 is stably accommodated in an internal space of the upper case 220, the lower case 210 may be coupled with the upper case 220. The first socket 131a and the second socket 131b provided on the upper surface of the bobbin 100 may be exposed to the outside through the socket through hole 221 provided in the upper portion of the upper case 220.

That is, after the bobbin case coupling operation as described above is completed, the first socket 131 and the first lead wire 111a positioned at the first socket 131a, the second socket 131b and the second lead wire 111b positioned at the second socket 131b, and the indicator 133 may be exposed to the outside from the bobbin case 200.

Also, to couple the lower case 210 with the upper case 220, the outer diameter of the lower case 210 may be equal or similar to the inner diameter of the upper case 200 such that the lower case 210 is inserted into and coupled with the upper case 220. Also, a coupling structure, such as a hook or a groove, may be provided on the outer circumferential surface of the lower case 210, and on the inner circumferential surface of the lower end of the upper case 220, a coupling structure, such as a groove or a hook, may be provided to couple the upper case 220 with the lower case 210.

Also, the outer circumferential diameter of the lower case 210 may be equal or similar to the outer circumferential diameter of the upper case 220 such that the lower end of the upper case 220 is rested on the upper surface of the lower case 210, which is not shown. In this case, on the lower end of the upper case 220, a coupling structure such as a hook protruding in the axial direction of the upper case 220 may be provided, and the lower case 210 may include a coupling structure such as a hole on a surface on which the lower end of the upper case 220 is rested, to couple the upper case 220 with the lower case 210.

Meanwhile, the pin housing coupling operation may be an operation of coupling the pin housing 300 with the bobbin case 200 such that the pin housing 300 surrounds at least one portion of the bobbin case 200 completely assembled as described above.

More specifically, in the pin housing coupling operation, by aligning the pin housing 300 above the bobbin case 200 and moving the bobbin case 200 or the pin housing 300 in the axial direction of the bobbin case 200 to couple the bobbin case 200 with the pin housing 300, the pin housing 300 may surround at least one portion of the bobbin case 200.

At this time, the bobbin case 200 and the pin housing 300 may be aligned based on the indicator 133 exposed upward from the bobbin case 200 and the indicator coupling hole 320 provided in the upper portion of the pin case 300.

Also, an inner circumferential diameter of the side portion of the pin housing 400 being in the shape of the hollow cylinder may be equal or similar to an outer circumferential diameter of a side portion of the bobbin case 200, and accordingly, the bobbin case 200 may be coupled with the pin housing 300 such that the entire upper surface of the bobbin case 200 and the entire or a part of the side surface of the bobbin case 200 are surrounded by the pin housing 300.

Meanwhile, the upper portion of the pin housing 300 may cover the entire upper surface of the bobbin case 200, and the side portion of the pin housing 300 being in the shape of the hollow cylinder may surround the entire side surface of the bobbin case 200, as described above. In this case, the pin housing 300 may include the coupling hook 330 at the lower end of the side portion. The coupling hook 330 may be coupled to the first coupling portion 224 provided at the lower end of the upper case 220 to couple the pin housing 300 with the bobbin case 200, as described above. Also, the coupling hook 330 may include the coupling hook slit 331 formed at both sides of the coupling hook 330 and extending in the axial direction of the pin housing 300 such that the coupling hook 330 is deformable in the diameter direction of the pin housing 300 while moving downward along the side surface of the upper case 220 in the axial direction of the bobbin case 220.

Accordingly, while the pin housing 300 is coupled with the bobbin case 200, the coupling hook 330 may move along the side surface of the bobbin case 200 in the state of opening in the diameter direction of the pin housing 300, and when the coupling hook 330 arrives at the first coupling portion 224, the coupling hook 330 may be restored and fixed to the first coupling portion 224. Also, at least two coupling hooks 330 may be provided to firmly fix the pin housing 300 to the bobbin case 200, like the first coupling portion 224.

Also, the first coupling portion 224 may be in a shape of a hook protruding from the side surface of the bobbin case 200, and the pin housing 300 may include a structure of a coupling hole or a coupling groove, instead of the coupling hook 330, to couple the pin housing 300 with the bobbin case 200, which is not shown.

Meanwhile, because the coupling hook 330 as described above moves in the axial direction of the bobbin case 200 while being in close contact with the side surface of the bobbin case 200 during a process of coupling the pin housing 300 with the bobbin case 200, the side surface of the bobbin case 200 may be damaged.

Accordingly, as shown in FIG. 10, the upper portion of the pin housing 300 may cover the entire upper surface of the bobbin case 200, and the side portion of the pin housing 300, which is in the shape of the hollow cylinder, may surround an upper portion of the side surface of the bobbin case 200.

In this case, the pin housing 300 may include the coupling groove 340 which is provided in the inner circumferential surface of the pin housing 300 and into which the second coupling portion 225 provided in a shape of a protrusion or a circular ring at an upper end portion of the upper case 220 is inserted, as described above.

Accordingly, the solenoid coil assembly according to the disclosure may fundamentally prevent damage that may occur on the side surface of the bobbin case 200 while the pin housing 300 is coupled with the bobbin case 200.

Also, the upper case 220 may further include the at least two support protrusions 226 protruding upward on the upper surface, as described above, to support the inner surface of the upper portion of the pin housing 300 in the pin housing coupling operation, thereby maintaining a gap between the upper surface of the bobbin case 200 and the inner surface of the upper portion of the pin housing 300. Accordingly, while the pin housing 300 is coupled with the bobbin case 200 in the axial direction of the bobbin case 200 in the method of manufacturing the solenoid coil assembly according to the disclosure, excessive insertion of the lead pin 310 into the socket 131 may be further prevented.

Also, as described above, in the pin housing coupling operation of coupling the pin housing 300 with the bobbin case 200, the indicator 133 may be accommodated in the indicator coupling hole 320 provided in the pin housing 300. At this time, the indicator 133 may be firmly fixed inside the indicator coupling hole 320 by the press-fit ribs 321 protruding toward the center of the indicator coupling hole 320 from the inner circumferential surface of the indicator coupling hole 320 and extending in the axial direction of the pin housing 300.

Also, as described above, in the pin housing coupling operation of coupling the pin housing 300 with the bobbin case 200, the lead pin 310 integrated into the pin housing 300 may be electrically connected to the lead wire of the coil 111 positioned at the socket 131 without performing a separate connection process.

More specifically, as shown in FIGS. 7 and 8, the lead pin 310 may include the plug portion 311 provided at the upper portion of the socket 131, the connector portion 312 provided at the center part of the upper portion of the pin housing 300, and the connection portion 313 connecting the plug portion 311 to the connector portion 312.

While the pin housing 300 is coupled with the bobbin case 200 in the axial direction of the pin housing 300, the lower end of the plug portion 311 may be inserted into the socket 131 to be electrically connected to the first lead wire 111a or the second lead wire 111b, as described above. To this end, the plug portion 311 may be positioned at a side of the upper portion of the pin housing 300 in the axial direction of the pin housing 300 such that the socket 131 is positioned at the lower portion of the plug portion 311.

Also, the plug portion 311 may include, as shown in FIG. 8, the coil coupling hole 311a which is in a shape of a hole and to which the first lead wire 111a or the second lead wire 111b entered the plug portion 311 through the slit opening downward is fixed.

Also, the upper end of the plug portion 311 may protrude from the upper surface of the pin housing 300 to easily manufacture a mold upon insert injection of the lead pin 310 and the pin housing 300 and firmly fix the lead pin 310 to the pin housing 300.

Also, because the upper end of the plug portion 311 protrudes from the upper surface of the pin housing 300, as described above, it may be possible to visually check whether the plug portion 311 is properly placed in the pin housing 300 in a process of manufacturing the solenoid coil assembly according to the disclosure.

The connector portion 312 may include the connector pin 312a protruding upward from the pin housing 300 to be electrically connected to a PCB, etc. provided in a vehicle control apparatus in which the solenoid coil assembly according to the disclosure is installed.

Also, the connector portion 312 may be provided at the center part of the upper portion of the pin housing 300 in the axial direction of the pin housing 300. Also, the connector portion 312 may further include, as shown in FIG. 7, the limiting protrusion 312b protruding from both sides of the connection pin 312a at the lower end of the connector pin 312a to prevent the connector pin 312a from being excessively inserted into the PCB, etc. Also, the lower end of the connector portion 312a may protrude from the lower surface of the upper portion of the pin housing 300 to firmly fix the lead pin 310 to the pin housing 300, as shown in FIG. 9. The lower end of the connector pin 312a may be spaced from the upper surface of the bobbin case 200 to be prevented from interfering with the sleeve (not shown), etc. of the valve assembly positioned on the inner circumferential surface of the bobbin body 110.

As shown in FIG. 8, the connection portion 313 may connect the plug portion 311 provided at the socket 131 to the connector portion 312 provided at the center part of the pin housing 300 inside the pin housing 300, as described above. Also, as shown in FIG. 9, an end of the connection portion 313 may protrude to a side of the plug portion 311 with respect to the diameter direction of the pin housing 300, and another end of the connection portion 313 may protrude to a side of the connector portion 312 with respect to the diameter direction of the pin housing 300 to firmly fix the lead pin 310 to the pin housing 300.

Also, the lead pin 310 configured as described above may include the first lead pin 310a and the second lead pin 310b that are adjacent to each other to be respectively coupled to the first socket 131a and the second socket 131b, as shown in FIG. 3. More specifically, the first lead pin 310a may be symmetrical to the second lead pin 310b with respect to an imaginary straight line passing the axial center of the pin housing 300 in the diameter direction of the pin housing 300, like the first socket 131a and the second socket 131b.

Also, each of the first lead pin 310a and the second lead pin 310b may include all of the plug portion 311, the connector portion 312, and the connection portion 313 to form the same shape as described above.

Accordingly, the method of manufacturing the solenoid coil assembly according to the disclosure may greatly improve productivity of a product by omitting a process and member for connecting the lead wires of the coil to the lead pins compared to a process of manufacturing the typical solenoid coil assembly because the first lead wire 111a and the second lead wire 111b are electrically connected to the first lead pin 310a and the second lead pin 310b, respectively, in the pin housing coupling operation.

The solenoid coil assembly and the manufacturing method thereof according to an embodiment may improve reliability of a product and reduce an error rate by preventing the socket or the lead pin from being deformed or damaged by an excessive force applied in the axial direction of the bobbin upon coupling between the lead pin and the socket at which the lead wire of the coil is positioned.

The solenoid coil assembly and the manufacturing method thereof according to an embodiment may further improve reliability of a product and reduce an error rate by preventing, upon coupling between the lead pin and the socket at which the lead wire of the coil is positioned, deformation or damage of the socket or the lead pin due to an excessive insertion amount of the lead pin with respect to the socket and a poor connection due to an insufficient insertion amount of the lead pin with respect to the socket.

The solenoid coil assembly and the manufacturing method thereof according to an embodiment may simplify a manufacturing process of a product and improve productivity by omitting a process for adjusting an appropriate height of the lead pin from the socket for stable coupling between the lead pin and the socket at which the lead wire of the coil is positioned.

The solenoid coil assembly according to an embodiment may further simplify a manufacturing process of a product and improve productivity because of being capable of omitting a member and process for connecting the lead pin to the lead wire of the coil in the state in which the socket at which the lead wire of the coil is positioned is coupled to the lead pin.

So far, the embodiments of the solenoid coil assembly according to the disclosure have been described in detail. However, it will be apparent that various modifications can be made without deviating from the scope of the disclosure.

Therefore, the scope of the disclosure should not be limited to the above-described embodiments and should be defined by the following claims and equivalents of the claims.

That is, it should be understood that the embodiments described above are merely for illustrative purposes and not for limitation purposes in all aspects. The scope of the disclosure is defined by the following claims, rather than the detailed description, and it should be interpreted that all changes or modified forms derived from the meanings, scope, and equivalent concepts of the claims are included in the scope of the disclosure.

What is claimed is:

1. A solenoid coil assembly, comprising:
a bobbin including a hollow bobbin body, a coil wound on the bobbin body, and a socket provided on an upper surface of the bobbin body, wherein a lead wire of the coil is positioned at the socket;
a bobbin case including a socket through hole through which the socket is exposed to outside, the bobbin case surrounding the bobbin; and
a pin housing formed integrally with a lead pin and coupled to the bobbin case, wherein the lead pin is physically and electrically connected to the lead wire positioned at the socket.

2. The solenoid coil assembly of claim 1, wherein the bobbin further comprises:
a lower flange provided in a lower portion of the bobbin body and configured to limit a lower winding range of the coil; and
an upper flange provided in an upper portion of the bobbin body and configured to limit an upper winding range of the coil, wherein the socket is provided at a side of an upper surface of the upper flange and an indicator is formed at an opposite side of the upper surface of the upper flange.

3. The solenoid coil assembly of claim 2, wherein the upper flange further comprises a lead wire through hole provided adjacent to the socket such that the lead wire of the coil is positioned at the socket.

4. The solenoid coil assembly of claim 2, wherein the bobbin case further comprises:
a lower case provided on a lower surface of the bobbin; and
an upper case coupled to the lower case and surrounding an upper surface and a side surface of the bobbin, wherein the socket through hole is provided at a side of an upper portion of the upper case and an indicator through hole through which the indicator is exposed to the outside is provided at an opposite side of the upper portion of the upper case.

5. The solenoid coil assembly of claim 4, wherein the upper case further comprises an inner circumferential extension portion bent toward an inner circumferential surface of the bobbin and surrounding an upper portion of the inner circumferential surface of the bobbin.

6. The solenoid coil assembly of claim 4, wherein the pin housing surrounds an upper surface and a side surface of the upper case, and comprises a coupling hook coupled with a first coupling portion provided at a lower end of the upper case.

7. The solenoid coil assembly of claim 6, wherein the pin housing further comprises coupling hook slits provided at both sides of the coupling hook and extending in an axial direction of the pin housing.

8. The solenoid coil assembly of claim 4, wherein the pin housing surrounds an upper surface of the upper case and an upper end of a side surface of the upper case, and comprises a coupling groove coupled to a second coupling portion provided at the upper end of the side surface of the upper case.

9. The solenoid coil assembly of claim 8, wherein the second coupling portion is either
a ring extending in a circumferential direction at the upper end of the side surface of the upper case, or
a protrusion protruding in a diameter direction from the upper end of the side surface of the upper case.

10. The solenoid coil assembly of claim 4, wherein the upper case further comprises at least one support protrusion supporting an inner surface of an upper portion of the pin housing.

11. The solenoid coil assembly of claim 4, wherein the pin housing comprises an indicator coupling hole accommodating an upper end of the indicator.

12. The solenoid coil assembly of claim 11, wherein the pin housing further comprises a press-fit rib protruding inwardly from an inner circumferential surface of the indicator coupling hole, extending in an axial direction of the pin housing, and configured to fix the upper end of the indicator.

13. The solenoid coil assembly of claim 1, wherein the bobbin case further comprises:
an upper portion through which the socket through hole is provided; and
at least one support protrusion extending upwardly from the upper portion of the bobbin case and supporting an upper portion of the pin housing.

14. The solenoid coil assembly of claim 1, wherein the lead pin comprises:
a plug portion provided at an upper portion of the pin housing and electrically connected to the lead wire of the coil positioned at the socket;
a connector portion protruding upward from the upper portion of the pin housing; and
a connection portion positioned inside the upper portion of the pin housing and connecting the plug portion to the connector portion.

15. The solenoid coil assembly of claim 14, wherein
an upper end of the plug portion protrudes upward from the pin housing, and
the plug portion comprises a coil coupling hole which is provided at a lower end of the plug portion and in which the lead wire of the coil is received to be physically and electrically connected to the lead pin.

16. The solenoid coil assembly of claim 14, wherein the connector portion comprises:
a connector pin protruding upward from the pin housing at an upper end of the connector portion, wherein a lower end of the connector pin protrudes from a lower surface of the upper portion of the pin housing.

17. The solenoid coil assembly of claim 1, wherein
the socket comprises:
a first socket at which a first lead wire of the coil is positioned; and
a second socket at which a second lead wire of the coil is positioned, and
the lead pin comprises:
a first lead pin, wherein at least one portion of the first lead pin is inserted in the first socket and is physically and electrically connected to the first lead wire; and
a second lead pin, wherein at least one portion of the second lead pin is inserted into the second socket and is physically and electrically connected to the second lead wire.

18. The solenoid coil assembly of claim 1, wherein
the bobbin further comprises an indicator on the upper surface of the bobbin body, and
the bobbin case further comprises an indicator through hole through which the indicator is exposed to the outside.

19. A method of manufacturing a solenoid coil assembly,
the solenoid coil assembly including:
a bobbin including a hollow bobbin body, a coil wound on the bobbin body, and a socket and an indicator provided on an upper surface of the bobbin body, wherein a lead wire of the coil is positioned at the socket,
a bobbin case including a socket through hole and an indicator through hole formed in an upper portion of the bobbin case, and
a pin housing integrated with a lead pin, including an indicator coupling hole,
the method comprising:
a bobbin case coupling operation of coupling the bobbin case with the bobbin, such that the bobbin case surrounds the bobbin, and the socket and the indicator are respectively exposed through the socket through hole and the indicator through hole; and
a pin housing coupling operation of coupling the pin housing with the bobbin case, such that the pin housing surrounds at least one portion of the bobbin case, an upper end of the indicator is accommodated in the indicator coupling hole, and a lower end of the lead pin is inserted in the socket and is physically and electrically connected to the lead wire positioned at the socket.

20. A kit for a solenoid coil assembly, comprising:
a bobbin including a hollow bobbin body, a coil wound on the bobbin body, and a socket provided on an upper surface of the bobbin body, wherein a lead wire of the coil is positioned at the socket;
a bobbin case including a socket through hole, wherein the bobbin case is configured to surround the bobbin, and the socket through hole is configured to expose the socket to outside; and
a pin housing formed integrally with a lead pin and configured to be coupled to the bobbin case, wherein the lead pin is configured to be physically and electrically connected to the lead wire of the coil positioned at the socket.
